(19) United States
(12) Patent Application Publication
(10) Pub. No.: US 2026/0298392 A1
(43) Pub. Date: Oct. 1, 2026

(54) APPARATUS FOR REMOVING PIPE THREAD PROTECTORS

(71) Applicant: Alexander Jacob Petkau, Richer (CA)

(72) Inventor: Alexander Jacob Petkau, Richer (CA)

(21) Appl. No.: 19/094,237

(22) Filed: Mar. 28, 2025

(51) Int. Cl. F16L 57/00

(52) U.S. Cl. CPC F16L 57/005

(57) ABSTRACT

Male and female thread protectors for the box and pin ends of pipe sections are removed by an apparatus including a first operating head for attachment to a rotary driving tool which has two pins of extending longitudinally of the rotary axis which are pointed so as to punch through a transverse inner circular web of the male protector to form openings and a second operating head having two pins mounted for adjustment of a position radially from the axis so as to accommodate openings in the transverse outer circular web of the female thread protector which are of different spacing.

This invention relates to an apparatus for removing thread protectors screwed onto respective ends of threaded pipe sections to protect the threads.

### BACKGROUND ART Many pipes including those used as a drill string or as a casing for a drilled well are formed of pipe sections which are connected end to end to complete the full length of the pipe.

Typically the pipe sections include at one end known as the box end a female thread formed into an internal surface and at the other end known as the pin end a male thread formed onto an external surface so that the male and female threads can be inter-engaged as the sections are connected end to end to form the complete pipe.

In well drilling the number of sections can be very large requiring that these be transported to and then stored on site and handled using grasping equipment to move them to the required location to be rotated to engage the threads.

It is essential to protect the threads from damage of during storage and bulk supply. Any damage can prevent the proper engagement of the threads. That is, many of the pipe sections can be laid in a stack on one another with the danger that such damage can occur.

Pipe threading on pipe sections that undergo handling has routinely been protected by thread protectors typically a sleeve of a plastic protective material screwed onto or into the pipe threading. These must be removed before the pipe is coupled to threaded joints. Particularly in the casing pipes used in oil wells, the threaded pipe is expensive and the threads need protection from damage.

Problems arise in removal of the thread protectors which may become deformed by impact, etc. in pipe handling. There has been no satisfactory wrench available on the market to remove the protectors. During removal it is required to assure that the pipe threads are not damaged by the removal by slipping of the wrench or by having to use unorthodox methods of removal because of dirty or damaged thread protectors which require considerable removal torque. Also, it is desirable to reuse the thread protectors, thus requiring removal without damage thereto.

That is, at the female end of the pipe is provided a male thread protector with a cylindrical sleeve which inserts into the female end of the pipe and carries an exterior thread thereon threaded into the female thread on the pipe. The cylindrical sleeve is closed across an inner end of the sleeve with a transverse inner circular web which is thus located inside the female end of the pipe. The cylindrical sleeve has a lip at an outer end of the sleeve which engages an end face of the female end of the pipe.

That is, at the male end of the pipe is provided a female thread protector with a cylindrical sleeve which surrounds the male end and carries an interior thread thereon threaded onto the male thread on the pipe. The cylindrical sleeve is closed across an outer end of the sleeve with a transverse outer circular web which is thus located outside or beyond the male end of the pipe. The cylindrical sleeve has an interior shoulder within the sleeve which projects inwardly and engages an end face of the male end of the pipe.

These male and female thread protectors thus are applied to the pipe sections at a remote location and remain in place during transport and storage. However when required for use they must be removed and preferably retained for re-use. As there are typically a large number of such male and female thread protectors, it is a significant task to remove these requiring significant torque to be applied and this needs to be done efficiently and accurately and safely.

### SUMMARY OF THE INVENTION

According to a first aspect of the invention there is provided an apparatus for use in removal of thread protectors for male and female ends of pipe sections where the male end includes an external male thread and the female end includes an internal female thread;
where, at the female end of the pipe section is provided a male thread protector with a cylindrical sleeve which inserts into the female end of the pipe section and carries an exterior thread thereon threaded into the female thread on the pipe section;
where the cylindrical sleeve of the male thread protector is closed across an inner end of the sleeve with a transverse inner circular web which is thus located inside the female end of the pipe section;
where, at the male end of the pipe section is provided a female thread protector with a cylindrical sleeve which surrounds the male end and carries an interior thread thereon threaded onto the male thread on the pipe section;
where the cylindrical sleeve is closed across an outer end of the sleeve with a transverse outer circular web which is thus located outside or beyond the male end of the pipe section;
the apparatus comprising:
a first operating head having a coupling for attachment to a rotary driving tool for rotation about a drive axis and a first connector portion for engaging and applying torque from the rotary driving tool to the male thread protector at the transverse inner circular web; and
a second operating head having a coupling for attachment to a rotary driving tool for rotation about a drive axis and a second connector portion for engaging and applying torque from the rotary driving tool to the female thread protector at the transverse outer circular web.

According to a second aspect of the invention there is provided an apparatus for use in removal of thread protectors for a female end of pipe sections where the female end includes an internal female thread;
where, at the female end of the pipe section is provided a male thread protector with a cylindrical sleeve which inserts into the female end of the pipe section and carries an exterior thread thereon threaded into the female thread on the pipe section;
where the cylindrical sleeve of the male thread protector is closed across an inner end of the sleeve with a transverse inner circular web which is thus located inside the female end of the pipe section;
the apparatus comprising:
a first operating head having a coupling for attachment to a rotary driving tool for rotation about a drive axis and a first connector portion for engaging and applying torque from the rotary driving tool to the male thread protector at the transverse inner circular web; and
wherein the first operating head includes two pins extending parallel to the drive axis for engaging into openings in the transverse inner circular web of the male thread protector.

According to a third aspect of the invention there is provided an apparatus for use in removal of thread protectors for a male end of pipe sections where the male end includes an external male thread;
where, at the male end of the pipe section is provided a female thread protector with a cylindrical sleeve which surrounds the male end of the pipe section and carries an interior thread thereon threaded onto the male thread on the pipe section;
where the cylindrical sleeve is closed across an outer end of the sleeve with a transverse outer circular web which is thus located outside or beyond the male end of the pipe section;
the apparatus comprising:
an operating head having a coupling for attachment to a rotary driving tool for rotation about a drive axis and a second connector portion for engaging and applying torque from the rotary driving tool to the female thread protector at the transverse outer circular web; wherein the operating head includes two pins extending parallel to the drive axis for engaging into openings in the transverse outer circular web of the female thread protector;
and wherein the two pins of the operating head are mounted for adjustment of a position thereof radially from the axis so as to accommodate openings in the transverse outer circular web of the female thread protector which are of different spacing.

Preferably the first operating head includes two pins extending parallel to the drive axis for engaging into openings in the transverse inner circular web of the male thread protector where the two pins of the first operating head are pointed so as to punch through the transverse inner circular web to form the openings.

In this arrangement preferably there is provided a hammer portion to apply force longitudinally of the two pins so as to punch through the transverse inner circular web to form the openings. The hammer portion can be attached to the attachment coupling for manual application of the force longitudinally while the coupling is attached to the rotary driver.

Preferably the two pins are mounted on an end mounting plate head shaped to engage into the cylindrical sleeve of the male thread protector.

In another preferred arranged for the second operating head, includes two pins extend parallel to the drive axis for engaging into existing openings in the transverse outer circular web of the female thread protector.

In this arrangement preferably the two pins of the second operating head are mounted for adjustment of a position thereof radially from the axis so as to accommodate openings in the transverse outer circular web of the female thread protector which are of different spacing.

This can be provided in an arrangement in which the second operating head includes a mounting plate with a plurality of receptacles at positions spaced from the axis each of which can be selected to receive and locate a respective one of the pins at a required spacing from the axis.

As another arrangement for a different type of male thread protector, the second operating head for engaging and applying torque from the rotary driving tool to the female thread protector at the transverse outer circular web includes a transverse bar for engagement into slots provided at an end of the female thread protector at or adjacent the transverse outer web.

The transverse bar for engagement into slots provided at an end of the female thread protector at or adjacent the transverse outer web can be mounted on the same mounting plate as the pins.

### BRIEF DESCRIPTION OF THE DRAWINGS

FIG. 1 is a side elevational view of a second tool according to the present invention for use in removing the female thread protector attached to the male end of a pipe section

FIG. 2 is an isometric view of the tool of FIG. 1.

FIG. 3 is a cross-sectional view of the tool of FIG. 1 inserted into the female thread protector.

FIG. 4 is a cross-sectional view of the tool of FIG. 1.

FIG. 5 is a front elevational view of the tool of FIG. 1.

FIG. 6 is an isometric view of the tool of FIG. 1.

FIG. 7 is a front elevational view of the tool of FIG. 1 including an adapter for use with a slotted arrangement of female thread protector.

FIG. 8 is a cross-sectional view of the tool of FIG. 7 inserted into the slotted female thread protector.

FIG. 9 is a side elevational view of a first tool according to the present invention for use in removing the male thread protector attached to the female end of a pipe section

FIG. 10 is an isometric view of the tool of FIG. 9.

FIG. 11 is a side elevational view of the tool of FIG. 9 inserted into the male thread protector.

FIG. 12 is a cros-sectional view of the tool of FIG. 9 inserted into the male thread protector.

### DETAILED DESCRIPTION

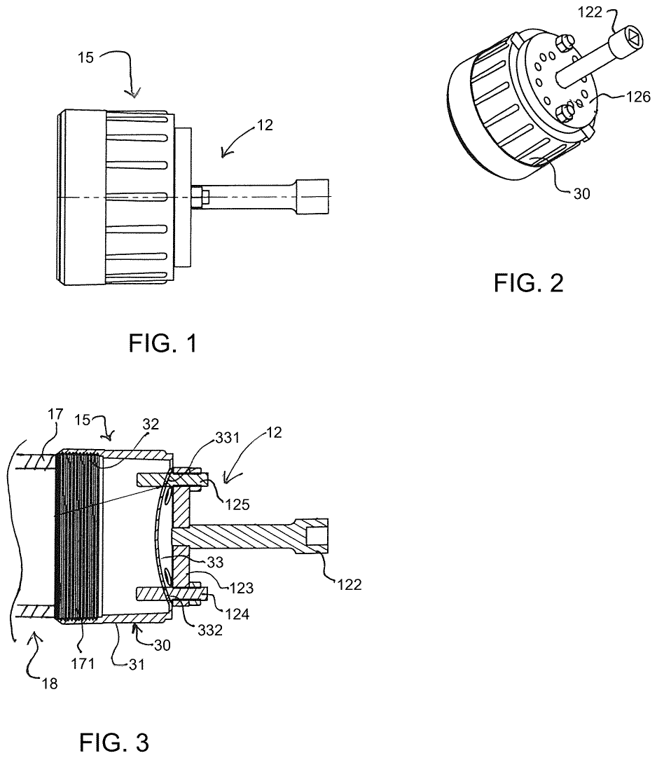

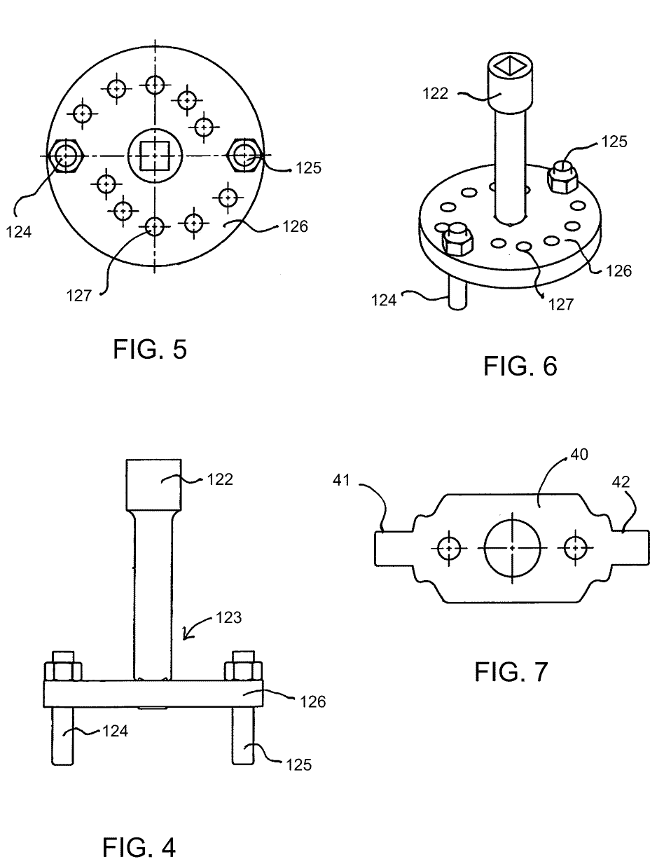

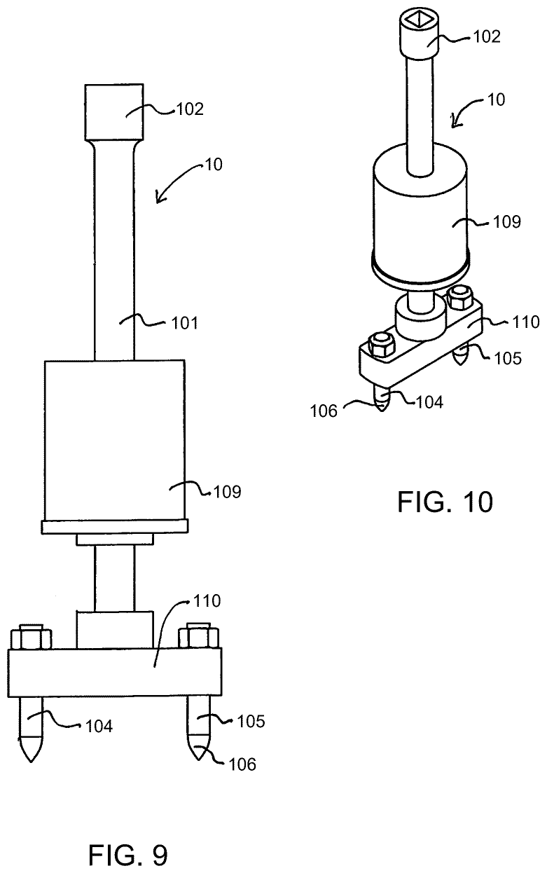

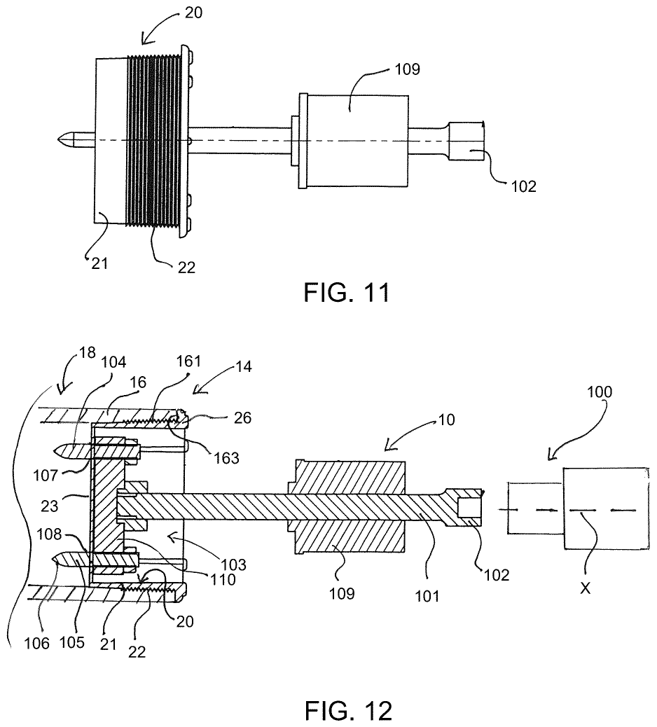

The apparatus as shown herein includes a first tool 10 shown in FIGS. 9 to 12 and second tool 12 shown in FIGS. 1 to 8. The combination of the two tools is arranged for use in removal of thread protectors 14 and 15 for female ends 16 and male ends 17 of pipe sections 18 shown only in respect of the ends in FIGS. 3 and 12. The male end 17 of the pipe section 18 includes an external male thread 171 and the female end 16 includes an internal female thread 161.

As shown in FIG. 12, at the female end 16 of the pipe section 18 is provided a male thread protector 20 with a cylindrical sleeve 21 which inserts into the female end 16 of the pipe section 18 and carries an exterior thread 22 thereon threaded into the female thread 161 on the pipe section. The cylindrical sleeve 21 of the male thread protector 20 is closed across an inner end of the sleeve 21 with a transverse inner circular web 23 which is thus located inside the female end 16 of the pipe section. The outer end of the sleeve 21 includes a peripheral rib 26 which butts against the end face 163 of the end 16 so as locate the male protector 20 at the end 16.

As shown in FIG. 3, at the male end 17 of the pipe section 18 is provided a female thread protector 30 with a cylindrical sleeve 31 which surrounds the male end 17 and carries an interior thread 32 thereon threaded onto the male thread 171 on the pipe section 18. The cylindrical sleeve 31 is closed across an outer end of the sleeve with a transverse outer circular web 33 which is thus located outside or beyond the male end 17 of the pipe section 18. The inner face of the sleeve 31 includes a shoulder 36 which butts against the circular end face 172 of the end 17 so as locate the female protector 30 at the end 17.

The above arrangement is a common construction used on many such pipe sections.

The apparatus for use in removing the thread protectors includes a first operating head 10 and the second operating head 12.

The first operating head 10 includes a shaft 101 with a coupling 102 of conventional shape for attachment to a rotary driving tool 100 such as a high power manually operable drill for rotation about a drive axis X and a first connector portion 103 for engaging and applying torque from the rotary driving tool 100 to the male thread protector 20.

The first operating head 10 includes at the connector portion 103 two pins 104 and 105 extending parallel to the drive axis X for engaging into openings 107 and 108 formed in the transverse inner circular web 23 of the male thread protector 20. The two pins 104 and 105 of the first operating head are pointed at 106 so as to punch through the transverse inner circular web 23 to form the openings.

In this arrangement preferably there is provided a hammer portion 109 mounted on the shaft 101 to apply force longitudinally of the two pins so as to punch through the transverse inner circular web to form the openings. The hammer portion is attached to the attachment coupling 102 for manual application of the force longitudinally while the coupling is attached to the rotary driver 100. The two pins are mounted on an end mounting plate 110 shaped to be received into the cylindrical sleeve 21 of the male thread protector 20.

The second operating head 20 includes a coupling 122 for attachment to the rotary driving too 100l and a second connector portion 123 for engaging and applying torque from the rotary driving tool to the female thread protector 30 at the transverse outer circular web 33.

The second operating head 123 includes two pins 124 and 125 which extend parallel to the drive axis for engaging into existing openings 331 and 332 in the transverse outer circular web 33 of the female thread protector 30.

In this arrangement the two pins 124 and 125 of the second operating head are mounted on a plate 126 by threaded nuts in a selected one of a series of holes 127 best shown in FIG. 5 for adjustment of a position thereof radially from the axis. This can be used to select the holes 127 which best match or accommodate openings 123 in the transverse outer circular web 33 which can be of different spacing.

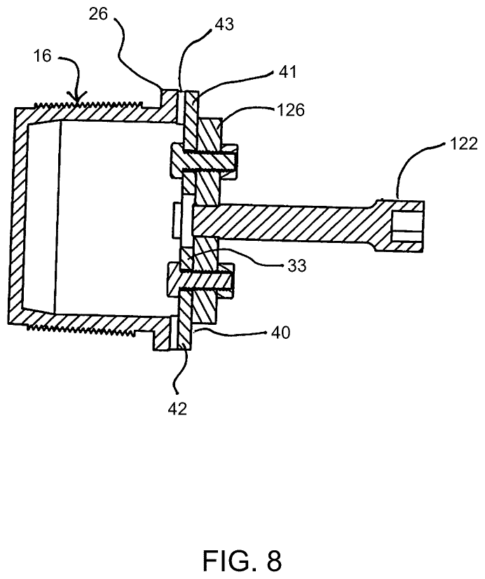

As shown in FIGS. 7 and 8 for a different type of male thread protector, the second operating head for engaging and applying torque from the rotary driving tool to the female thread protector at the transverse outer circular web includes a transverse bar 40 with end projecting elements 41 and 42 for engagement into slots 43 provided at the outer end of the female thread protector 16 at or adjacent the transverse outer web 33.

The transverse bar 40 can be mounted on the same mounting plate 126 as the pins 124 and 125 with the pins removed.

1. Apparatus for use in removal of thread protectors for male and female ends of pipe sections where the male end includes an external male thread and the female end includes an internal female thread;
where, at the female end of the pipe section is provided a male thread protector with a cylindrical sleeve which inserts into the female end of the pipe section and carries an exterior thread thereon threaded into the female thread on the pipe section;
where the cylindrical sleeve of the male thread protector is closed across an inner end of the sleeve with a transverse inner circular web which is thus located inside the female end of the pipe section;
where, at the male end of the pipe section is provided a female thread protector with a cylindrical sleeve which surrounds the male end and carries an interior thread thereon threaded onto the male thread on the pipe section;
where the cylindrical sleeve is closed across an outer end of the sleeve with a transverse outer circular web which is thus located outside or beyond the male end of the pipe section;
the apparatus comprising:
a first operating head having a coupling for attachment to a rotary driving tool for rotation about a drive axis and a first connector portion for engaging and applying torque from the rotary driving tool to the male thread protector at the transverse inner circular web; and
a second operating head having a coupling for attachment to a rotary driving tool for rotation about a drive axis and a second connector portion for engaging and applying torque from the rotary driving tool to the female thread protector at the transverse outer circular web.

2. The apparatus according to claim 1 wherein the first operating head includes two pins extending parallel to the drive axis for engaging into openings in the transverse inner circular web of the male thread protector.

3. The apparatus according to claim 2 wherein the two pins of the first operating head are pointed so as to punch through the transverse inner circular web to form the openings.

4. The apparatus according to claim 3 wherein there is provided a hammer portion to apply force longitudinally of the two pins so as to punch through the transverse inner circular web to form the openings.

5. The apparatus according to claim 4 wherein the hammer portion is attached to the attachment coupling for manual application of the force longitudinally.

6. The apparatus according to claim 2 wherein the two pins are mounted on an end mounting plate head shaped to engage into the cylindrical sleeve of the male thread protector.

7. The apparatus according to claim 1 wherein the second operating head includes two pins extending parallel to the drive axis for engaging into openings in the transverse outer circular web of the female thread protector.

8. The apparatus according to claim 7 wherein the two pins of the second operating head are mounted for adjustment of a position thereof radially from the axis so as to accommodate openings in the transverse outer circular web of the female thread protector which are of different spacing.

9. The apparatus according to claim 7 wherein the second operating head includes a mounting plate with a plurality of receptacles at positions spaced from the axis each of which can be selected to receive and locate a respective one of the pins at a required spacing from the axis.

10. The apparatus according to claim 1 wherein the second operating head for engaging and applying torque from the rotary driving tool to the female thread protector at the transverse outer circular web includes a transverse bar for engagement into slots provided at an end of the female thread protector at or adjacent the transverse outer web.

11. The apparatus according to claim 10 when dependent on claim 9 wherein the transverse bar for engagement into slots provided at an end of the female thread protector at or adjacent the transverse outer web is mounted on the mounting plate.

12. Apparatus for use in removal of thread protectors for a female end of pipe sections where the female end includes an internal female thread;
where, at the female end of the pipe section is provided a male thread protector with a cylindrical sleeve which inserts into the female end of the pipe section and carries an exterior thread thereon threaded into the female thread on the pipe section;
where the cylindrical sleeve of the male thread protector is closed across an inner end of the sleeve with a transverse inner circular web which is thus located inside the female end of the pipe section;
the apparatus comprising:
a first operating head having a coupling for attachment to a rotary driving tool for rotation about a drive axis and a first connector portion for engaging and applying torque from the rotary driving tool to the male thread protector at the transverse inner circular web; and
wherein the first operating head includes two pins extending parallel to the drive axis for engaging into openings in the transverse inner circular web of the male thread protector.

13. The apparatus according to claim 12 wherein the two pins of the first operating head are pointed so as to punch through the transverse inner circular web to form the openings.

14. The apparatus according to claim 13 wherein there is provided a hammer portion to apply force longitudinally of the two pins so as to punch through the transverse inner circular web to form the openings.

15. The apparatus according to claim 14 wherein the hammer portion is attached to the attachment coupling for manual application of the force longitudinally.

16. The apparatus according to claim 14 wherein the two pins are mounted on an end mounting plate head shaped to engage into the cylindrical sleeve of the male thread protector.

17. Apparatus for use in removal of thread protectors for a male end of pipe sections where the male end includes an external male thread;
where, at the male end of the pipe section is provided a female thread protector with a cylindrical sleeve which surrounds the male end of the pipe section and carries an interior thread thereon threaded onto the male thread on the pipe section;
where the cylindrical sleeve is closed across an outer end of the sleeve with a transverse outer circular web which is thus located outside or beyond the male end of the pipe section;
the apparatus comprising:
an operating head having a coupling for attachment to a rotary driving tool for rotation about a drive axis and a second connector portion for engaging and applying torque from the rotary driving tool to the female thread protector at the transverse outer circular web;
wherein the operating head includes two pins extending parallel to the drive axis for engaging into openings in the transverse outer circular web of the female thread protector;
and wherein the two pins of the second operating head are mounted for adjustment of a position thereof radially from the axis so as to accommodate openings in the transverse outer circular web of the female thread protector which are of different spacing.

18. The apparatus according to claim 17 wherein the second operating head includes a mounting plate with a plurality of receptacles at positions spaced from the axis each of which can be selected to receive and locate a respective one pf the pins at a required spacing from the axis.

19. The apparatus according to claim 18 wherein the operating head for engaging and applying torque from the rotary driving tool to the female thread protector at the transverse outer circular web includes a transverse bar for engagement into slots provided at an end of the female thread protector at or adjacent the transverse outer web.

20. The apparatus according to claim 19 wherein the transverse bar for engagement into slots provided at an end of the female thread protector at or adjacent the transverse outer web is mounted on the mounting plate.
